(19) United States
(12) Patent Application Publication
(10) Pub. No.: US 2015/0221157 A1
(43) Pub. Date: Aug. 6, 2015

(54) INLET MOUTH DEVICE FOR THE VERTICAL FEEDING OF A BANKNOTE COUNTING DEVICE AND A BANKNOTE COUNTING DEVICE USING IT

(71) Applicant: CMS GROUP S.R.L., Segrate (MI) (IT)

(72) Inventor: Giuseppe Storniolo, Milano (IT)

(21) Appl. No.: 14/427,274

(22) PCT Filed: Sep. 6, 2013
(86) PCT No.: PCT/IB2013/058348

§ 371 Date: Mar. 10, 2015

(30) Foreign Application Priority Data
Sep. 10, 2012 (IT) MI2012A001500

(51) Int. Cl. G07D 11/00; B65H 3/14; B65H 3/08; G07F 17/32; B65H 1/02

(52) U.S. Cl. CPC G07D 11/0018; G07F 17/322; G07F 17/3241; G07F 17/3246; B65H 1/02; B65H 3/08; B65H 3/14; B65H 2404/612; B65H 2404/6922; B65H 2701/1912

(57) ABSTRACT

The present invention refers to an inlet mouth device for the vertical feeding of a banknote counting device and to a banknote counting device using such a mouth, wherein the inlet mouth has an introduction chute with a prevalently vertical development, wherein the introduction chute defines a sliding surface equipped with a plurality of holes situated in fluid connection with at least one ventilator means.

The present invention refers to an inlet mouth device for the vertical feeding of a banknote counting device and to a banknote counting device using such a mouth.

Banknote counting devices known today are advantageously equipped for many different applications like for example, for bank cash desks that foresee the possibility of depositing cash, for supermarkets, for automatically counting cash when closing the tills, and even more commonly, in casinos, bookmakers and gaming rooms for converting cash into the equivalent value in chips.

Banknote counting devices are known comprising a feeding block through which the banknotes are consecutively conveyed towards a reading block where the counting, valorisation and verification of the authenticity of said notes occur. In particular, the valorisation consists of identifying the value of each single banknote based upon specific parameters like for example the dimensions.

Subsequently, according to the type of counting device, the counted banknotes are sent towards a discharge compartment, so as to be taken again, or towards a safe-deposit box contained inside the counting device, in such a way completing a deposit.

Some known banknote counting devices with the possibility of depositing in addition provide the implementation of the so-called “escrow” function, which allows the user, if he desires, to get back the banknotes before confirming the deposit. Such a function requires the presence of a special compartment that can be selectively accessed from outside in the case in which the deposit operation is cancelled, in which the banknotes are positioned after being counted, valorised and verified.

The feeding block of the banknotes are divided, in particular, in various distinct types. A first type comprises a container for housing a pack of banknotes and note separation means for taking the banknotes housed in the container. The note separation means are generally made up of a cylinder provided with a plurality of radial protrusions that have a hook-like shape, each of which, when the cylinder is set in rotation, engages with a single banknote, conveying it towards the reading block. Such a type of feeding block in general requires a large bulk.

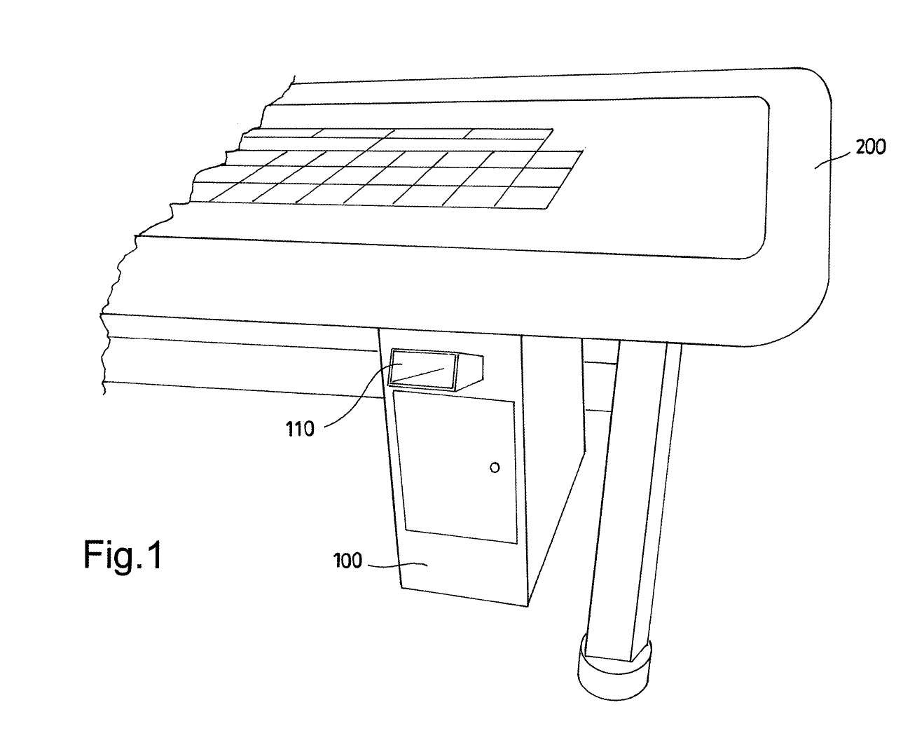

A second type of feeding block with smaller bulk, schematically shown in FIG. 1, provides for the presence of means for blocking a pack of banknotes positioned in the mouth, for example made through a pincer, and means for conveying single banknotes inside the device, in general consisting of a motorised wheel, possibly covered by a material with high friction coefficient at the surface in contact with the banknote. Such a feeding block is notoriously associated with an inlet mouth 110 made in the form of a substantially horizontal guide that makes it possible to minimise the effects of gravity, which is a frequent cause of jamming of the banknotes.

In particular, when used in casinos, it is important for the counting device, in addition to having small bulk, to be accessible at the surface of the table, so that a player who desires to insert an amount of cash to obtain the corresponding value in chips can visually monitor the entire operation of insertion of the banknotes into the device, generally carried out by the croupier.

However, as shown in FIG. 1, in order to minimise the bulk of the banknote counting device 100, it is preferable to position them below the gambling table 200. Such a positioning of the counting device, in association with the feeding blocks nowadays used in known counting devices, makes it impossible for the player to see the insertion of the banknotes carried out by the croupier, possibly leading to disputes.

The purpose of the present invention is to avoid the drawbacks mentioned above and in particular that of conceiving an inlet mouth for the vertical feeding of a banknote counting device that allows the player to watch the entire insertion step even when the device is positioned below a gambling table.

Another purpose of the present invention is to provide an inlet mouth device for the vertical feeding of a banknote counting device that is substantially free from jamming problems of the banknotes.

A further purpose of the present invention is that of making a banknote counting device with vertical feeding using such a mouth.

These and other purposes according to the present invention are achieved by making an inlet mouth device for the vertical feeding of a banknote counting device as outlined in claim 1.

Further characteristics of the inlet mouth device for the vertical feeding of a banknote counting device are object of the dependent claims.

The characteristics and the advantages of an inlet mouth device for the vertical feeding of a banknote counting device according to the present invention shall become clearer from the following description, given as an example and not for limiting purposes, with reference to the attached schematic drawings, in which:

FIG. 1 is a perspective view, in the operative configuration, of a banknote counting device using an inlet mouth according to the prior art;

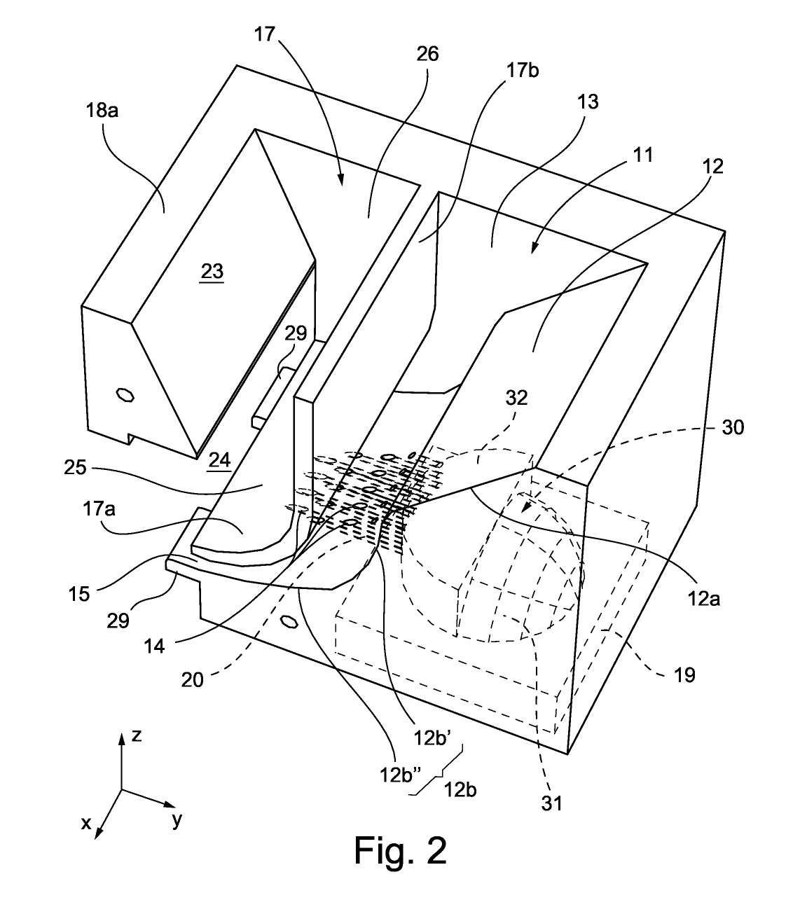

FIG. 2 is a perspective exploded view of a preferred embodiment of an inlet mouth for the vertical feeding of a banknote counting device according to the present invention;

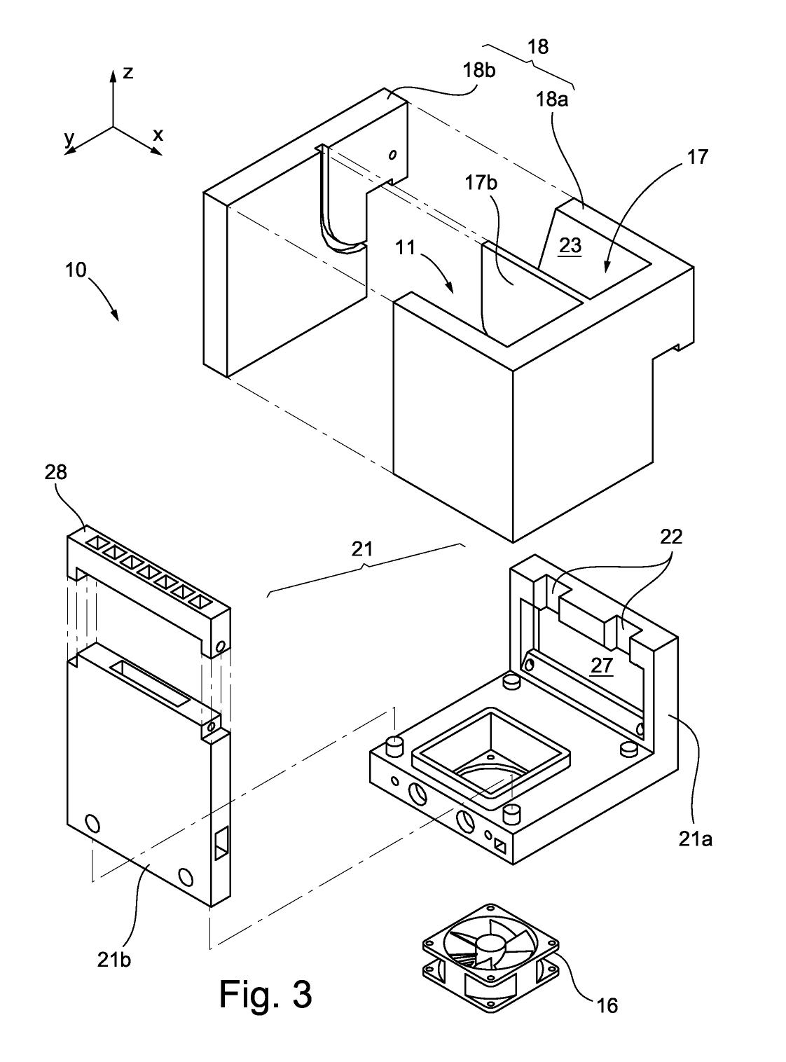

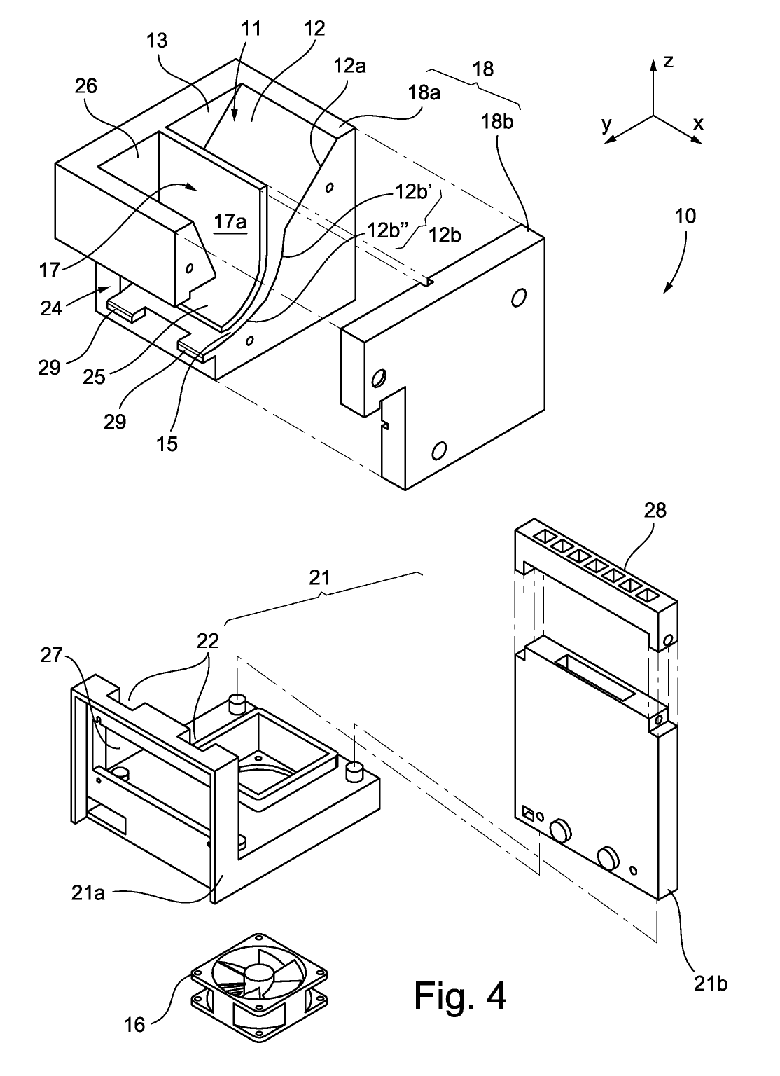

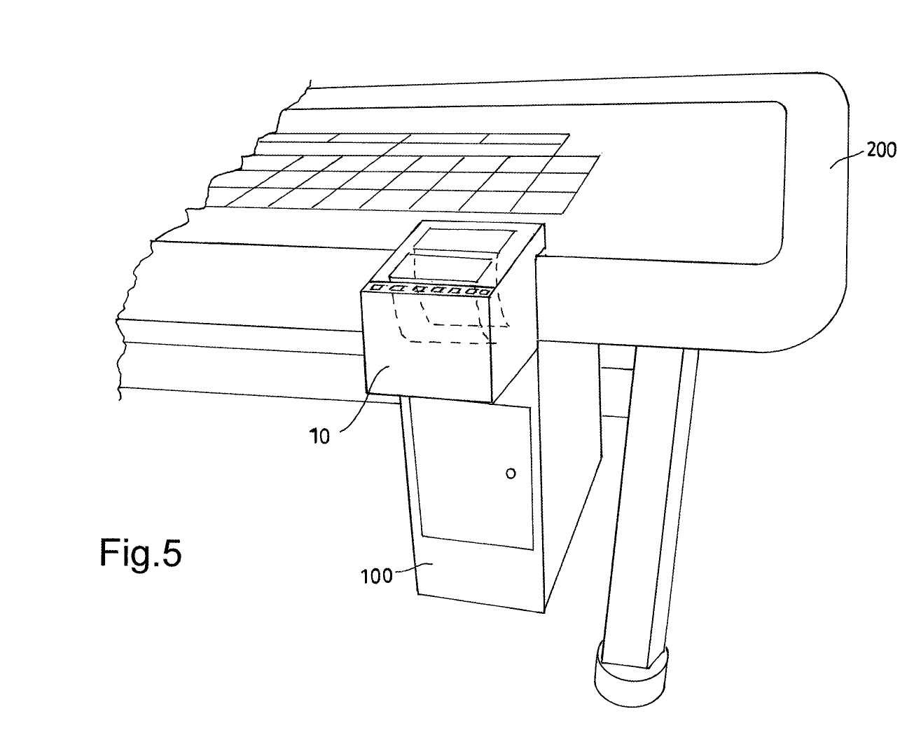

FIG. 3 is a perspective view, in operative configuration, of a banknote counting device using the inlet mouth of FIG. 2.

With reference to the figures, an inlet mouth for the vertical feeding of a banknote counting device is shown, wholly indicated with reference numeral 10. According to the present invention, the inlet mouth device 10 comprises a chute 11 for introducing the banknotes with a prevalently vertical development, wherein by mainly vertical development of a chute we mean a chute defining a sliding path having one component along the reference axis Z perpendicular to the ground surface that is greater than the component parallel to the ground surface, in other words with an inclination of more than 45° with respect to the ground surface.

The introduction chute 11 has a plurality of holes 14 on its sliding surface 12 that are situated in fluid connection with at least one ventilator means 16, so as to convey a flow of air towards the sliding surface 12 of the introduction chute 11, in such a way forming an air cushion between the banknotes and such a sliding surface 12.

In such a way it is possible to minimise the effects caused by adhesion, gravity and/or electrostatic phenomena acting on the banknotes, which could, among other things, stop the advancing of the banknote in direct contact with the sliding surface 12 of the introduction chute 11 or other phenomena that can cause jamming.

Preferably, the sliding surface 12, with a surface 17b overlooking it, defines a channel for introducing the banknotes with a mainly vertical development.

Such an introduction channel has, with respect to the reference axis Z, an inlet 13 at the top and an outlet at the bottom for conveying one or more banknotes towards a feeding block of a banknote counting device 100 to which the mouth 10 can be associated.

In the preferred embodiment illustrated, the sliding surface 12 comprises a first portion for receiving banknotes 12a having a linear conformation and, preferably, without holes 14.

A second portion 12b of the sliding surface 12 is moreover provided having a curved conformation, in turn consisting of a first section 12b′ with an upper, substantially vertical, inclination and a second section 12b″ with a lower inclination, for joining the substantially vertical section 12b′ to the outlet 15.

In a preferred but not limiting manner, the inlet mouth device 10 in addition comprises a discharge chute 17, having a substantially parallel development with respect to the introduction chute 11, that is suitable for receiving the banknotes that have been discarded from the banknote counting device 100, or rather the banknotes that the reading block has identified as counterfeit, or that it has not been able to valorise, for example in a currency that is not recognised by the device, and that the feeding block has thus re-conveyed out from the device.

The discharge chute 17 preferably comprises a front sliding surface 17a and a back surface 17b that faces the sliding surface 12 of the introduction chute 11, defining with it the channel for introducing the banknotes.

The front sliding surface 17a of the discharge chute 17 defines, with a surface 23 overlooking it, a channel for ejecting the banknotes.

Such an ejection channel has, with respect to the reference axis Z, at the bottom, an inlet 25 and at the top an outlet 26 for ejecting one or more banknotes that have been re-conveyed out from the feeding block of the banknote counting device 100 to which the mouth 10 can be associated.

Preferably, the injection and ejection chutes 11, 17 are made inside a box-shaped casing 18.

The box-shaped casing 18 comprises a seat 19 for housing the ventilator means 16 from which a plurality of aeration channels 20 starts each terminating in a hole 14 of the plurality of holes 14 present on the sliding surface 12 of the introduction chute 11.

The aeration channels 20 are preferably arranged perpendicularly with respect to the flow of air that can be generated by the ventilator means positioned in their own housing seat 19.

The flow of air generated by the ventilator means 16 is directed towards a conjoining space 30 delimited above by a hemispheric cap 31 and a semicylindrical portion 32, wherein the aeration channels 20 start from the curved wall of the semicylindrical portion 32.

Such a particular conformation of the conjoining space 30 between the ventilator means 16 and the aeration channels 20 promotes the compression and the conveying of the flow of air inside the aeration channels 20.

The box-shaped casing 18 is preferably made in at least two parts 18a, 18b reciprocally and releasably constrained so as to allow the channels for introducing and/or ejecting the banknotes to be easily accessed during maintenance operations.

The box-shaped casing 18 can be constrained to a banknote counting device 100 at the relative feeding block of the banknotes.

For such a purpose, the box-shaped casing 18 comprises an open portion 24 made on a perimetric wall of the casing 18 for the direct connection between the feeding block and the outlet 15 of the introduction channel, as well as the inlet 25 of the ejection channel of the banknotes.

Preferably, the box-shaped casing 18 can be constrained to a banknote counting device 100 in a releasable manner so as to allow an easier access to the feeding block in the case in which there is jamming.

For such a purpose it is provided a supporting element that can be constrained in a fixed manner to the banknote counting device 100 and that is suitable for creating a removable constraining seat for the box-shaped casing 18.

In the preferred embodiment illustrated, the supporting element 21 consists of a U-shaped rod, that can be preferably decomposed into at least two parts 21a, 21b and that is equipped with releasable engagement grooves with protrusions 29 provided on at least one perimetric wall of the box-shaped casing 18.

The supporting element 21 is moreover provided with a window 27 that is suitable for being placed over the open portion 24 of the box-shaped casing 18, when the box-shaped casing 18 is engaged with the supporting element 21.

Such a supporting element 21, in the configuration in which it is constrained to the banknote counting device 100, is positioned at the relative feeding block so as to keep the direct connection between the feeding block and the outlet 15 of the introduction channel, as well as the inlet 25 of the ejection channel of the banknotes free.

The supporting element 21 preferably creates a housing of a plurality of control buttons 28 as well as the relative wiring and/or circuitry for driving the banknote counting device 100 provided with the inlet mouth device 10 according to the present invention.

A banknote counting device 100 according to the present invention, in a manner that is known at the state of the art, comprises a feeding block (not illustrated) through which banknotes are consecutively sent towards a reading block (not illustrated) where the counting, the valorisation and the verification of the authenticity of the banknotes is carried out.

Preferably, the banknote counting device 100 comprises a safe-deposit box (not illustrated) inside it for depositing banknotes after they have been counted.

Preferably, the banknote counting device 100 comprises a compartment (not illustrated) selectively accessible from outside in the case in which the depositing operation is cancelled, into which the banknotes are placed after being counted, valorised and verified.

In a preferred but not limiting manner, the feeding block of the banknote counting device 100 comprises means (not illustrated) for blocking a pack of banknotes, for example made like a pincer in a manner known at the state of the art, and means (not illustrated) for conveying the single banknote inside the device 100, preferably consisting, in a manner that is known at the state of the art, of a motorised wheel, possibly covered with a material with high friction coefficient at the surface in contact with the banknote.

According to the present invention, the banknote counting device 100 comprises an inlet mouth device 10 that is equipped with a chute 11 for introducing the banknotes with a prevalently vertical development and on the surface of which a series of holes 14 for introducing air are made, wherein the mouth device 10 is positioned in such a way that the outlet 15 of the introduction chute 11 terminates at an inlet of the feeding block of the device 100.

The operation of the inlet mouth device 10 for the vertical feeding of a banknote counting device 100 is as follows.

One or more banknotes are inserted in the introduction chute 11 and are made to slide towards the feeding block of the banknote counting device 100 to which the mouth device 10 is associated.

The flow of air generated by the ventilator means 16 and conveyed out from the holes 14 present on the sliding surface 12 of the introduction chute 11 with a prevalently vertical development generates an air cushion between such a sliding surface and the banknote in direct contact with it. In such a way the effects caused by physical phenomena that lead to jamming of the banknotes in the feeding block of the counting device are counteracted, thus facilitating the advancing of the entire group of banknotes inserted in the mouth towards the feeding block.

From the description carried out the characteristics of the inlet mouth device for the vertical feeding of a banknote counting device object of the present invention are clear, just like the relative advantages are also clear.

The overall conformation of the banknote counting device provided with an inlet mouth device for vertical feeding allows the player to monitor the entire insertion operation of the banknotes also in the case in which the device is positioned below a gambling table.

Indeed, in such a configuration, as shown in FIG. 3, the inlet of the introduction chute of the banknotes of the mouth is in any case flush with the gambling table, and therefore in the field of vision of the player.

Moreover, the particular configuration of the introduction chute ensures a substantial absence of jamming phenomena which, to this day, have indeed made it impossible to use vertical feeding mouths.

Finally, it is clear that the inlet mouth thus conceived can undergo numerous modifications and variants, all covered by the invention; moreover, all the details can be replaced by technically equivalent elements. In practice the materials used, as well as the dimensions, can be any according to the technical requirements.

1. An inlet mouth device (10) for the vertical feeding of a banknote counting device (100) characterized in that it comprises an introduction chute (11) with a prevalently vertical development, said introduction chute (11) defining a sliding surface (12) equipped with a plurality of holes (14) situated in fluid connection with at least one ventilator means (16).

2. The inlet mouth device (10) for the vertical feeding of a banknote counting device (100) according to claim 1, characterized in that said sliding surface (12) comprises a portion (12b) having a curved conformation consisting of a first section (12b′) with an upper inclination and a second section (12b″) with a lower inclination.

3. The inlet mouth device (10) for the vertical feeding of a banknote counting device (100) according to claim 1 or 2, characterized in that at an inlet (13) of said introduction chute (11), said sliding surface (12) comprises a portion for receiving banknotes (12a) having a linear conformation.

4. The inlet mouth device (10) for the vertical feeding of a banknote counting device (100) according to any of the previous claims, characterized in that it comprises a discharge chute (17) having a substantially parallel development with respect to said introduction chute (11).

5. The inlet mouth device (10) for the vertical feeding of a banknote counting device (100) according to any of the previous claims, characterized in that it comprises a box-shaped casing (18), said box-shaped casing (18) internally defining a housing seat (19) for said at least one ventilator means (16), a plurality of aeration channels (20) deriving from said housing seat (19), each terminating in a hole (14) of said plurality of holes (14) present on said sliding surface (12) of said introduction chute (11).

6. The inlet mouth device (10) for the vertical feeding of a banknote counting device (100) according to claim 5, characterized in that between said housing seat (19) and said aeration channels (20) there is a conjoining space (30) delimited above by a hemispheric cap (31) and by a semicylindric portion (32), said aeration channels (20) starting from the curved wall of said semicylindric portion (32).

7. The inlet mouth device (10) for the vertical feeding of a banknote counting device (100) according to claim 5 or 6, characterized in that said box-shaped casing (18) consists of at least two parts (18a, 18b) reciprocally and releasably constrained.

8. The inlet mouth device (10) for the vertical feeding of a banknote counting device (100) according to any of the claims from 5 to 7, characterized in that said box-shaped casing (18) comprises an open portion (24) on a perimetric wall of said casing (18) so as to allow access to at least one outlet (15) of said introduction chute (11).

9. The inlet mouth device (10) for the vertical feeding of a banknote counting device (100) according to any of the claims from 5 to 8, characterized in that it comprises a supporting element (21) that can be constrained and fixed to a banknote counting device (100) and suitable for creating a removable constraining seat for said box-shaped casing (18).

10. The inlet mouth device (10) for the vertical feeding of a banknote counting device (100) according to claim 9, characterized in that said supporting element (21) consists of a U-shaped rod equipped with releasable engagement grooves (22) with protrusions (29) present on at least one perimetric wall of said box-shaped casing (18).

11. The inlet mouth device (10) for the vertical feeding of a banknote counting device (100) according to claim 9 or 10, characterized in that said supporting element (21) comprises a window (27) suitable for being overlapped with said open portion (24) of said box-shaped casing (18), when said box-shaped casing (18) is engaged with said supporting element (21).

12. A banknote counting device (100) comprising a feeding block through which banknotes are sent consecutively towards a reading block for the counting, valorization and verification of the authenticity of said banknotes, characterized in that it comprises an inlet mouth device (10) for vertical feeding according to any of the previous claims, said inlet mouth device (10) being positioned so that an outlet (15) of said introduction chute (11) is situated at an inlet of said feeding block.
